(19) United States
(12) Patent Application Publication
(10) Pub. No.: US 2025/0063526 A1
(43) Pub. Date: Feb. 20, 2025

(54) OFFLOADING NETWORK COMMUNICATIONS TO A SHARED MODEM

(71) Applicant: GOOGLE LLC, Mountain View, CA (US)

(72) Inventors: Jayachandran Chinnakkannu, Santa Clara, CA (US); Hui Wang, Buffalo Grove (CA)

(21) Appl. No.: 18/721,560

(22) PCT Filed: Dec. 15, 2022
(86) PCT No.: PCT/US2022/053009

§ 371 Date: Jun. 18, 2024

Related U.S. Application Data
(60) Provisional application No. 63/291,510, filed on Dec. 20, 2021.

(51) Int. Cl. H04W 60/04; H04W 8/20; H04W 12/06; H04W 12/40; H04W 88/18

(52) U.S. Cl. CPC H04W 60/04; H04W 8/205; H04W 12/06; H04W 12/40; H04W 88/18

(57) ABSTRACT

Shared modems discrete from user equipment (UE) or other user devices are configured to facilitate the reception and transmission of network messages between UE and a cellular network. The shared modems are connected to consistent power sources and are configured to communicatively couple to UE or other user devices using one or more communication protocols and communicatively couple to one or more cells of a cellular network using one or more cellular network protocols. Once coupled to the UE or other user devices and the cellular network, the shared modems allow network messages to be transmitted and received between the UE or other user devices and the cellular network.

### BACKGROUND

User devices including compute-enabled phones (smartphones), compute-enabled wearable devices (e.g., smartwatches, fitness trackers), home security devices, tablet computers, laptop computers, mobile hotspots, and other user equipment (UE) use subscriber identity module (SIM) cards to provide reliable cellular network connectivity when there is no Wi-Fi connectivity available. These SIM cards are tightly coupled to internal modems of these user devices, requiring the user devices to include internal modems in order to have cellular network connectivity. However, such internal modems consume large amounts of power as they are constantly paging the cellular network. Such large consumptions of power diminish the battery life of the user devices.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a cellular networking framework for offloading network communications between user devices and a cellular network to one or more shared modems, in accordance with some embodiments.

FIG. 2 is a block diagram of a network message offloading framework for an external shared modem configured to offload one or more network communications between one or more user devices and a cellular network, in accordance with some embodiments.

FIG. 3 is a block diagram of a network message offloading framework for an internal shared modem configured to offload one or more network communications between one or more user devices and a cellular network, in accordance with some embodiments.

FIGS. 4 to 6 are signal flow diagrams together representing an example authentication process of a user device on a cellular network that is offloaded to a shared modem, in accordance with some embodiments.

FIG. 7 is a flow diagram of an example method for offloading network communications between user devices and a cellular network to one or more shared modems, in accordance with some embodiments.

FIG. 8 is a block diagram of a discovery and access framework for an external shared modem, in accordance with some embodiments.

FIG. 9 is a flow diagram of an example method for discovering and accessing an external shared modem, in accordance with some embodiments.

### DETAILED DESCRIPTION

Shared modems discrete from user devices or other UE are configured to facilitate the reception and transmission of network messages between user devices a cellular network. The shared modems are connected to consistent power sources and are configured to communicatively couple to user devices using one or more communication protocols and communicatively couple to one or more cells of a cellular network using one or more cellular network protocols. Once coupled to the user devices and the cellular network, the shared modems allow network messages to be transmitted and received between the user devices and the cellular network. In this way, one or more network messages between the user devices and the cellular network are offloaded to the shared modem, for example, network messages related to the authentication of the user devices. By offloading the network messages to the shared modem, user devices not including internal modems gain cellular network connectivity. Additionally, offloading the network messages to the shared modem lessens the power consumption of any internal modem a user device includes, extending the battery life of the user device.

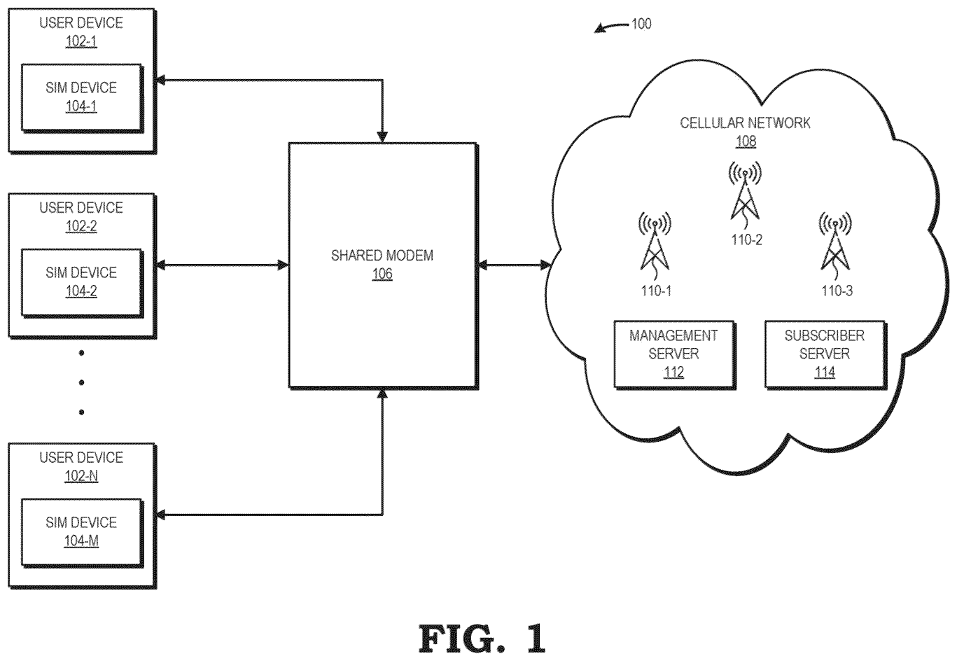

FIG. 1 presents a cellular networking framework 100 configured to offload network communications between user devices 102 and a cellular network 108 to one or more shared modems 106. In embodiments, cellular networking framework 100 includes cellular network 108 configured to transmit and receive one or more network messages to and from one or more user devices 102, for example, a Global System for Mobile Communication (GSM) cellular network, a Universal Mobile Telecommunications System (UMTS) cellular network, a Long-Term Evolution (LTE) cellular network, a 5G New Radio (NR) cellular network, 5G Technical Forum (5GTF), a 5G Special Interest Group cellular network (5G-SIG), or any combination thereof. Network messages transmitted and received by cellular network 108 include, for example, telephone calls, Voice over Internet Protocol (VoIP) calls, Short Message Service (SMS) messages, Multimedia Messaging Service (MMS) messages, authentication messages, registrations messages, update messages, attach messages, service request messages, or any combination thereof, to name a few. To facilitate the transmission and reception of network messages between cellular network 108 and user devices 102, cellular network 108 includes one or more cells 110 configured to receive and transmit network messages to and from one or more user devices 102. Each cell 110 include, for example, mobile base station towers (e.g., “cell towers”), antennae, transmitters, receivers, digital signal processors, control electronics, Global Positioning System (GPS) receivers, base transceiver stations, or any combination thereof, configured to receive and transmit network messages to and from one or more user devices 102. Though the example embodiment illustrated in FIG. 1 presents the cellular network 108 having three cells 110-1, 110-2, and 110-3, in other embodiments, cellular network 108 may include any number of cells 110 to facilitate the reception and transmission of network messages to and from one or more user devices 102.

User devices 102 configured to transmit and receive network messages from cellular network 108 include, for example, compute-enabled phones (“smartphones”), tablet computers, personal computers, laptop computers, Internet of Things (IoT) devices, routers, mobile hotspot devices, or any combination thereof, to name a few. In embodiments, to transmit and receive network messages from cellular network 108, a user device 102 is configured to communicatively couple to one or more cells 110 of the cellular network 108. In response to being communicatively coupled to one or more cells 110, the user device 102 is configured to transfer and receive network messages to and from cellular network 108, other user devices 102 communicatively coupled to one or more cells of cellular network 108, or both. That is to say, in response to being communicatively coupled to one or more cells 110, a user device 102 is communicatively coupled to one or more other user devices 102 via cellular network 108. For example, in the illustrated embodiment of FIG. 1, in response to being communicatively coupled to cell 110, user device 102-1 is communicatively coupled to user devices 102-2 and 102-N via the cellular network 108. Though the example embodiment illustrated in FIG. 1 presents three user devices 102-1, 102-2, 102-N representing an N number of user devices communicatively coupled via cellular network 108, in other embodiments, any number of user devices 102 may be communicatively coupled via cellular network 108.

According to embodiments, in response to a user device 102 being communicatively coupled to one or more cells 110, cellular network 108 is configured to authenticate and register the user device 102 before it is communicatively coupled to other user devices 102 via cellular network 108. That is to say, cellular network 108 authenticates a user device 102 before transmitting one or more network messages from user device 102 to one or more other user devices 102 communicatively coupled to cellular network 108, transmitting one or more network messages from other user devices 102 communicatively coupled to cellular network 108 to the user device 102, or both. For example, cellular network 108 authenticates a user device 102 before transmitting a telephone call to the user device 102 from another user device 102 communicatively coupled to cellular network 108. To authenticate one or more user devices 102, cellular network 108 includes one or more management servers 112 each including one or more physical servers, virtual servers, or both configured to authenticate one or more user devices 102 communicatively coupled to one or more cells 110 of cellular network 108.

In embodiments, a management server 112 authenticates a user device 102 by, for example, comparing identification data (e.g., user identification data, device identification data) associated with the user device 102 to data stored in a subscriber server 114 that includes one or more physical servers, virtual servers, or both configured to store authentication information (e.g., a list of authenticated devices, a list authenticated users, identification data of authenticated devices, authentication information of authenticated users), user profiles (user identification data, user location information, user service information), or both associated with cellular network 108. For example, to authenticate a user device 102 communicatively coupled to a cell 110 of cellular network 108, management server 112 receives device identification data and user identification data associated with a user device 102 and compares the received device identification data and user identification data to device identification data and user identification data stored in subscriber server 114. In response to the comparison indicating that the user device 102 is authenticated (e.g., the received device identification data, user identification data, or both match at least a portion of the device identification data, user identification data, or both stored in subscriber server 114), the management server 112 authenticates the user device 102 such that the user device is configured to transmit and receive one or more network messages to one or more other user devices 102 communicatively coupled to cellular network 108. In embodiments, to authenticate a user device 102, a management server 112 is further configured to, for example, store device identification data, user identification data, or both associated with the user device 102 in a subscriber server 114, generate registration data for the authenticated user device 102, determine services for the authenticated user device 102, or any combination. For example, in response to a comparison indicating that a user device 102 is authenticated, a management server 112 is configured to determine one or more services for the authenticated user device 102 based on user location information and user service information stored in subscriber server 114.

According to embodiments, one or more user devices 102 include or are otherwise coupled to one or more subscriber identity module (SIM) devices 104 configured to store device identification data, user identification data, or both associated with a respective user device 102. For example, in the example embodiment illustrated in FIG. 1, user device 102-1 includes or is otherwise coupled to sim device 104-1 configured to store device identification data, user identification data, or both associated with user device 102-1. Each SIM device 104 includes, for example, a SIM card (e.g., full-size card, mini card, micro card, nano card), universal subscriber identity module (USIM), embedded SIM (eSIM), integrated SIM (iSIM), or any combination thereof. The device identification data and user identification data stored by a sim device 104 includes, for example, SIM device identification data (e.g., Integrated Circuit Card Identification (ICCID) values, authentication keys (e.g., K_{I})), subscriber data (e.g., international mobile subscriber identity (IMSI), local area identity data), or both. Though the example embodiment illustrated in FIG. 1 presents three SIM devices 104-1, 104-2, 104-M, representing an M number of SIM devices each associated with a respective user device 102, in other embodiments, any number of SIM devices 104 may be associated with any number of user devices 102. In embodiments, one or more user devices 102 are configured to transmit at least a portion of the device identification data, user identification, or both stored in a respective SIM device 104 to cellular network 108. For example, a user device 102 is configured to transmit at least a portion of the device identification data, user identification, or both stored in a respective SIM device 104 to cellular network 108 to authenticate the user device 102 on cellular network 108.

In embodiments, framework 100 includes shared modem 106 configured to offload one or more network messages, device identification data, user identification data, or any combination thereof from user devices 102, cellular network 108, or both. That is to say, shared modem 106 is configured to transmit network messages, device identification data, user identification data, or any combination thereof received from a user device 102 to cellular network 108 and transmit network messages, device identification data, user identification data, or any combination thereof received from cellular network 108 to one or more user devices 102. For example, shared modem 106 is configured to transmit one or more phone calls received from cellular network 108 to one or more authenticated user devices 102. Shared modem 106 includes, for example, one or more broadband processors, application processors, GSM modems, UMTS modems, LTE modems, a 5G NR modems, 5GTF modems, 5G-SIG modems, or any combination thereof configured to provide cellular connectivity to one or more user devices 102. To provide cellular connectivity, shared modem 106 is configured to communicatively couple to one or more user devices 102 using one or more communication protocols that include, for example, Universal Serial Bus (USB), Thunderbolt, Ethernet, Bluetooth (e.g., Bluetooth Low Energy), Near Field Communication (NFC), Radio Frequency ID (RFID), Wi-Fi, ultra-wideband (UWB) communications, or any combination thereof. Further, to provide cellular connectivity to the user devices 102, shared modem 106 is configured to communicatively couple to one or more cells 110 of cellular network 108 using one or more cellular protocols, for example, GSM, UMTS, LTE, a 5G NR, 5GTF, 5G-SIG, or any combination thereof. In response to being coupled to a user device 102 and a cell 110 of cellular network 108, shared modem 106 is configured to communicatively couple the user device 102 to the cellular network 108 such that one or more network messages, device identification data, user identification data, or any combination thereof can be received and transmitted between the user device 102 and cellular network 108. In this way, a user device 102 does not require an internal modem, allowing the user device 102 to not include an internal modem or allowing the user device 102 to place an internal modem in a low-power setting. By not requiring an internal modem for the user device 102, the power consumption of the user device 102 is reduced as the user device 102 does not need to power an internal modem to connect to cellular network 108.

According to embodiments, shared modem 106 is a discrete device from one or more user devices 102. For example, shared modem 106 is a separate device from one or more user devices 102. In embodiments, shared modem 106 is powered by a consistent power source, for example, an alternating current (A/C) power outlet, an alternator, a car battery, a power grid, an inverter, or any combination thereof, to name a few. According to some embodiments, shared modem 106 is mechanically coupled, or fixed, to one or more structures, for example, structures in a residential building (e.g., walls, ceilings, floors, support beams, framings), commercial building (e.g., walls, ceilings, floors, support beams, framings), structures in a vehicle (e.g., frames, dashboards, consoles, interiors), or any combination thereof. For example, shared modem is fixed to a console of a car. In this way, the shared modem 106 is consistently powered allowing the shared modem 106 to connect to more user devices 102 to facilitate communications with cellular network 108.

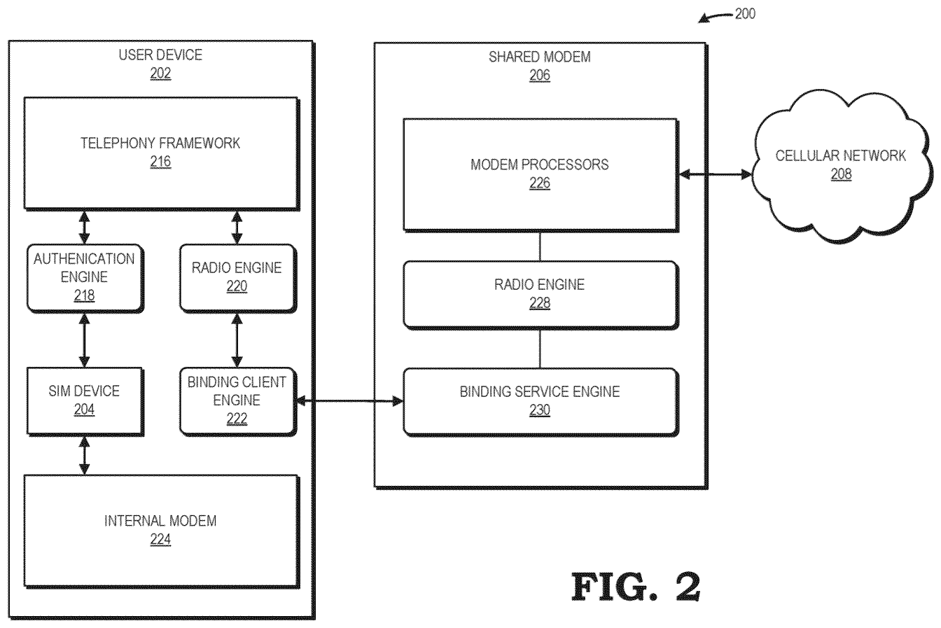

Referring now to FIG. 2, a network message offloading framework 200 for an external shared modem 206 configured to offload one or more network communications between one or more user devices 202 and a cellular network 208 is presented. In embodiments, the shared modem 206, similar to or the same as shared modem 106, is discrete and separate from one or more user devices 202. In embodiments, the shared modem 206 includes binding engine 230 that includes hardware and software configured to communicatively couple to one or more user devices 202, similar to or the same as user devices 102, using one or more communication protocols. For example, binding engine 230 is configured to broadcast that the shared modem 206 is available over one or more communication protocols. The shared modem 206 further includes radio engine 228 including hardware and software configured to process, generate, and determine one or more message transmit requests, network messages, network responses, or any combination thereof. For example, radio engine 228 is configured to determine one or more network messages based on a message transmit request received from a user device 202 communicatively coupled to the shared modem 206. The shared modem 206 additionally includes one or more modem processors 226 (e.g., baseband modem processors) configured to communicatively couple to a cellular network 208, similar to or the same as cellular network 108, so that network messages and network responses are transmitted and received between the shared modem 206 and the cellular network 208.

To facilitate communications between the user device 202 and the shared modem 206, the user device 202 communicatively coupled to the shared modem 206 includes binding client engine 222 that includes hardware and software configured to communicatively couple to one or more shared modems 206. For example, binding client engine 222 is configured to determine one or more shared modems 206 that are available and proximate (e.g., within one or more communication protocols' ranges) to the user device 202. The user device 202 further includes a telephony framework 216 including hardware and software (e.g., touchscreens, speakers, microphones, processing circuitry, processing applications, buttons) to manage one or more network messages, message transmit requests, or both received or generated by the user device 202. For example, the telephony framework 216 is configured to output at least a portion of one or more received network messages, provide inputs to at least a portion of one or more transmit message requests, or both. As another example, the telephony framework 216 is configured to output the audio of one or more telephone calls. As yet another example, the telephony framework 216 is configured to receive a voice input for one or more phone calls. The user device 202 also includes a SIM device 204 configured to store identification data (e.g., device identification data, user identification data) related to the user device 202, identification data (e.g., device identification data, user identification data) related to a user associated with the user device 202, or both. The user device 202 also includes authentication engine 218 including hardware and software (e.g., application programming interfaces (APIs)) configured to assist in authenticating the user device 202 on the cellular network 208. For example, authentication engine 218 is configured to read data from the SIM device 204 and provide it to the telephony framework 216. The telephony framework 216 then, for example, uses the read data from the SIM device 204 as an input to a message transmit request. To facilitate the generation and reception of network messages, the user device 202 includes radio engine 220 that includes hardware and software configured to determine, generate, and handle one or more network messages. For example, radio engine 220 includes hardware and software configured to generate network messages for the placing, reception, and operation of telephone calls based on inputs received from the telephony framework. As another example, radio engine 220 includes hardware and software configured to handle the reception of network messages (e.g., generating parameters to be output by the telephony framework based on the received network messages). As yet another example, radio engine 220 is configured to generate one or more message transmit requests based on inputs received at the telephony framework. In some embodiments, the user device 202 includes internal modem 224 that is placed in a low-power state, for example, in response to the user device 202 being communicatively coupled to the shared modem.

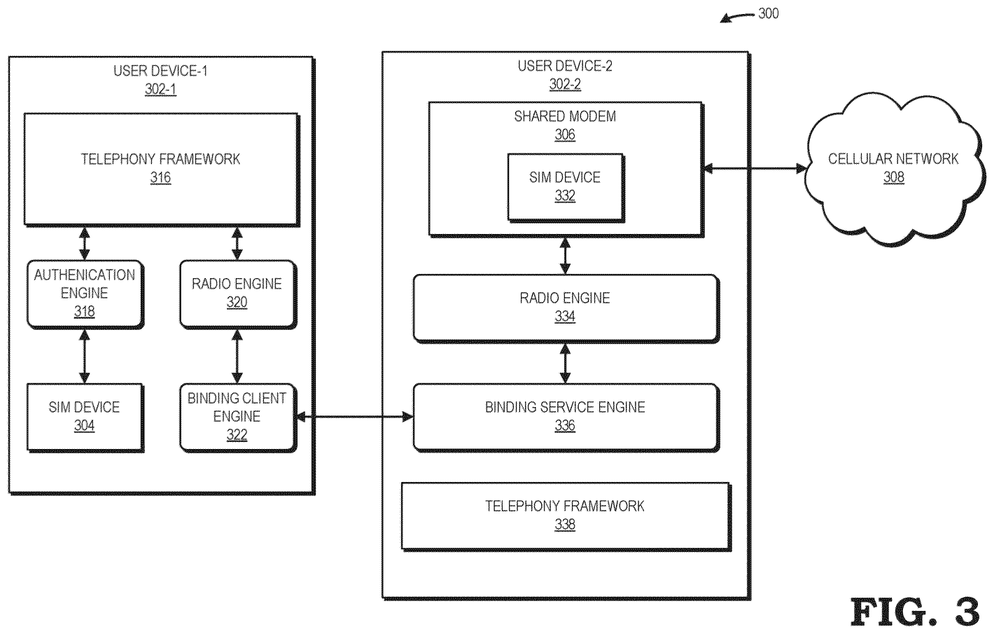

FIG. 3 illustrates a network message offloading framework 300 for a shared modem that is included in one or more user devices 302. In the framework 300, a user device 302-2, similar to or the same as user devices 102, 202, is configured to communicatively couple to a cellular network 308, similar to or the same as cellular networks 108, 208, using an internal shared modem 306, similar to or the same as shared modem 106. In embodiments, in response to the user device 302-2 communicatively coupling to the cellular network 308, the cellular network 308 is configured to authenticate the user device 302-2 based on identification data stored in the SIM device 332 of the user device 302-2. In embodiments, the SIM device 332 is tightly coupled to the internal shared modem 306. The user device 302-2 further includes a telephony network 316 configured to handle network messages transmitted to and received from the cellular network 308. Further, in the framework 300, the user device 302-2 with an internal shared modem 306 includes a binding service engine 336 configured to communicatively couple to one or more other user devices, for example, user device 302-1, similar to or the same as user devices 102, 202, using one or more communication protocols. User device 302-1 includes, for example, SIM device 304, similar to or the same as SIM devices 104, 204, authentication engine 318, similar to or the same as authentication engine 218, telephony network 316 similar to or the same as telephony network 216, radio engine 320, similar to or the same as radio engine 220, and binding client engine 322, similar to or the same as binding client engine 232. In response to being communicatively coupled to the other user device 302-1, the user device 302-2 with the internal shared modem 306 offloads network messages between the other user device 302-1 and the cellular network 308 similar to or the same as shared modem 206 discussed above with reference to FIG. 2.

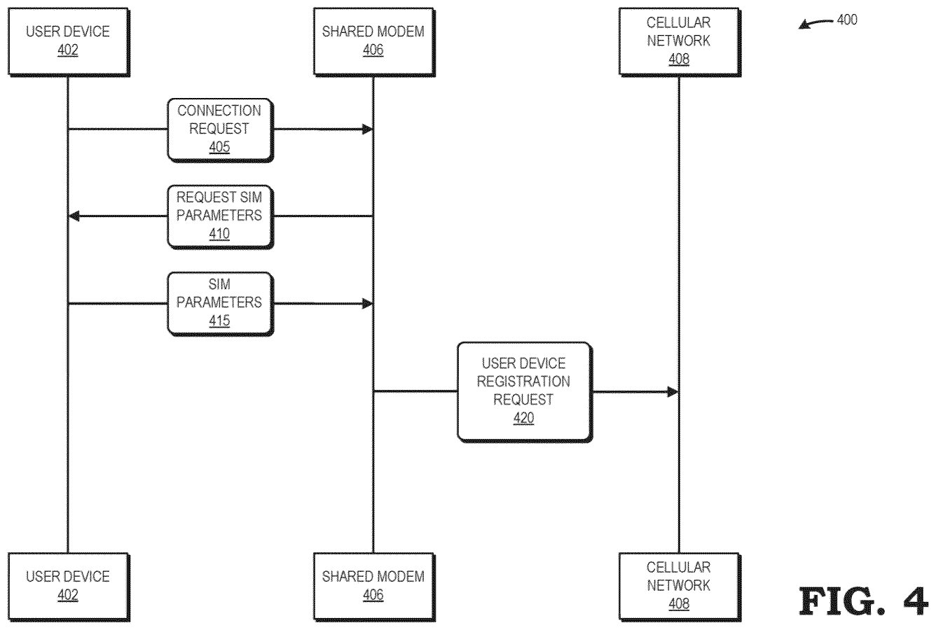

FIGS. 4 to 6 together illustrate a flow diagram for an authentication process 400 of a user device on a cellular network that is offloaded to a shared modem. Referring now to FIG. 4, The authentication process 400 includes a user device 402, similar to or the same as user devices 102, 202, 302, communicatively coupleable to a shared modem 406, similar to or the same as shared modem 106, 206, 306, using one or more communication protocols. In embodiments, the authentication process 400 includes a user device 402 transmitting a connection request 405 associated with one or more communication protocols to a shared modem 406. In response to receiving the connection request 405, the shared modem is configured to communicatively couple to the user device 402 using one or more of the communication protocols associated with the connection request 405. According to embodiments, in response to communicatively coupling to the user device 402, the shared modem 406 is configured to read or request identification data (e.g., device identification data, user identification data) stored in a SIM device, similar to or the same as SIM devices 104, 204, 304, of the user device 402. For example, the shared modem 406 is configured to transmit a request for SIM parameters 410 to user device 402. In embodiments, the request for SIM parameters 410 includes data requesting at least a portion of the identification data stored in one or more SIM devices associated with the user device 402. In response to receiving the request for SIM parameters 410, the user device 402 is configured to transmit at least a portion of the identification data stored in an associated SIM device to the shared modem 406. For example, the user device 402 is configured to transmit one or more SIM parameters 415 (e.g., ICCID, IMSI, authentication key) to the shared modem 406. According to embodiments, in response to receiving one or more SIM parameters 415, the shared modem 406 stores, updates, or both one or more SIM parameters associated with the user device 402 that are stored on the shared modem 406.

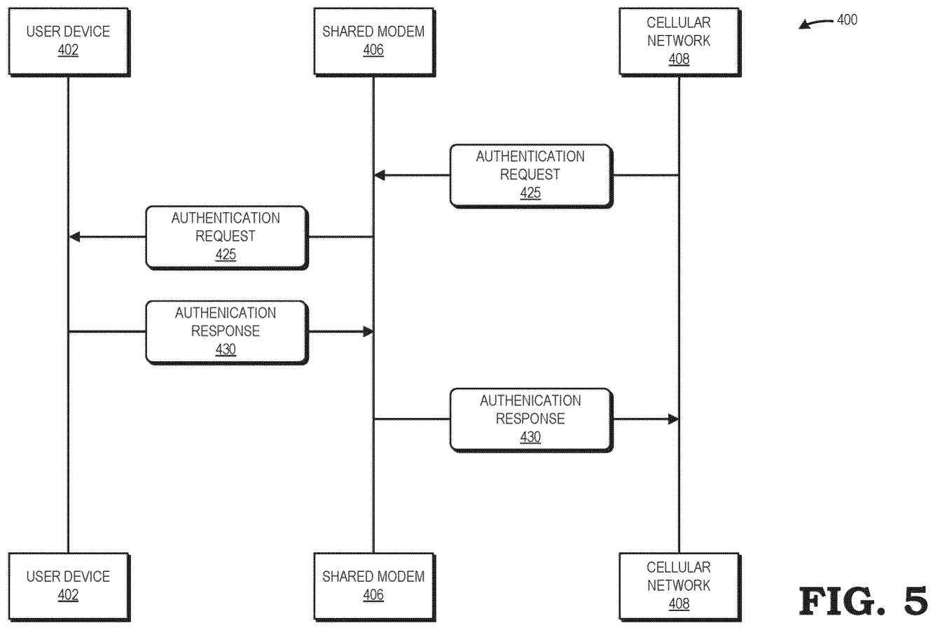

In embodiments, the shared modem 406 initiates the authentication of the user device 402 on the cellular network 408 by transmitting a user device registration request 420 to the cellular network 408. The user device registration request 420 includes, for example, data identifying the user device 402 (e.g., a device identification number), data requesting the registration of the user device 402, or both. Referring now to FIG. 5, in response to receiving the user device registration request 420, the cellular network 408 generates an authentication request 425 that includes data requesting identification data from the user device 402 associated with the user device registration request 420 (e.g., the user device 402 identified in the user device registration request 420). The cellular network 408 transmits the authentication request 425 to the shared modem 406 which, in turn, provides the authentication request 425 to the user device 402. In response to receiving the authentication request 425 from the shared modem 406, the user device 402 transmits an authentication response 430 to the shared modem 406. The authentication response 430 includes, for example, at least a portion of the identification data stored in the SIM device associated with the user device 402. In response to receiving the authentication response 430 from the user device 402, the shared modem 406, provides the authentication response 430 to the cellular network 408. The cellular network 408 then authenticates the user device 402 based on the authentication response 430. For example, the cellular network 408 compares at least a portion of the identification data in the authentication response 430 to identification data stored in a subscriber server similar to or the same as subscriber server 114.

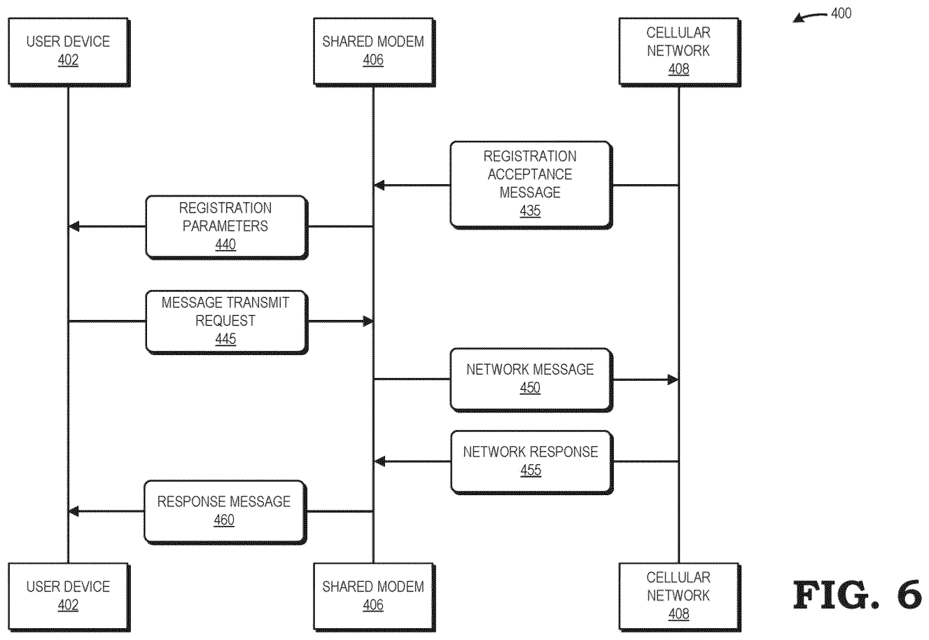

Referring now to FIG. 6, after the cellular network 408 authenticates the user device 402, the cellular network 408 transmits a registration acceptance message 435 to the shared modem 406. According to embodiments, the registration acceptance message 435 includes one or more registration parameters 440 (e.g., network status, access technology type, cellular network identification value, active time, periodic TAU, location area code) used to determine, generate, or handle network messages transmitted to and from the user device 402. For example, the user device 402 generates one or more message transmit requests 445 for one or more network messages 450 based on the registration parameters 440 in the registration acceptance message 435. As another example, the shared modem 406, user device 402, or both determine one or more response messages 460 including outputs for the telephony framework of the user device 402 based on one or more network responses 455 and one or more registration parameters 440. In response to receiving the registration acceptance message 435 from the cellular network 408, the shared modem 406 determines one or more registration parameters 440 from the registration acceptance message 435 and provides the parameters to the user device 402. For example, the shared modem 406 identifies one or more registration parameters 440 in the registration acceptance message 435.

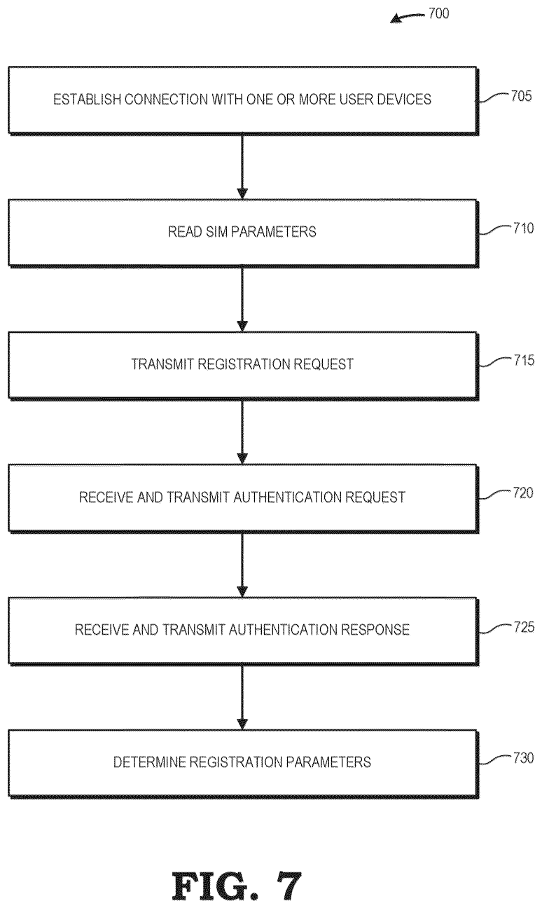

Referring now to FIG. 7, an example method 700 for offloading the authentication of a user device on a cellular network to a shared modem is presented. At step 705, a shared modem, similar to or the same as shared modem 106, 206, 406, that is communicatively coupled to one or more cellular networks, similar to or the same as cellular networks 108, 208, 308, 408, communicatively couples to one or more user devices, similar to or the same as user devices 102, 202, 302, 402, using one or more communication protocols. At step 710, in response to communicatively coupling to a user device, the shared modem is configured to read at least a portion of the identification data stored in a SIM device, similar to or the same as SIM device 104, 204, 304, associated with the user device. For example, the shared modem is configured to request at least a portion of the identification data (e.g., device identification data, user identification data) stored in the SIM device associated with the user device. At step 715, the shared modem transmits a user device registration request, similar to or the same as user device registration request 420, to the cellular network. For example, the shared modem transmits data identifying the user device and registration status of the user device. At step 720, in response to receiving the user device registration request, the cellular network generates and transmits an authentication request, similar to or the same as authentication request 425, to the shared modem. For example, the cellular network generates a network message including data requesting at least a portion of the identification data stored in the SIM device associated with the user device identified in the user device registration request. In response to receiving the authentication request from the cellular network, the shared modem transmits the authentication request to the user device.

At step 725, the user device generates and transmits an authentication response, similar to or the same as authentication response 430, to the shared modem. For example, the user device generates a message transmit request for a network message including at least a portion of the identification data stored in the SIM device associated with the user device. In response to receiving the authentication response, the shared modem transmits the authentication response to the cellular network. At step 730, the cellular network generates a registration acceptance message, similar to or the same as registration acceptance message 435 and transmits the registration acceptance message to the shared modem. For example, the cellular network transmits data identifying one or more registration parameters (e.g., network status, access technology type, cellular network identification value, active time, periodic TAU, location area code) to the shared modem. In response to receiving the registration acceptance message, the shared modem is configured to determine one or more registration parameters. For example, the shared modem is configured to identify one or more registration parameters from the registration acceptance message. In response to determining one or more registration parameters, the shared modem is configured to transmit one or more determined registration parameters to the user device. According to embodiments, the shared modem is configured to transmit network messages to and from the user device using the one or more registration parameters (e.g., network status, access technology type, cellular network identification value, active time, periodic TAU, location area code). For example, the shared modem is configured to determine one or more outputs for the telephony framework of a user device based on one or more network messages and one or more registration parameters.

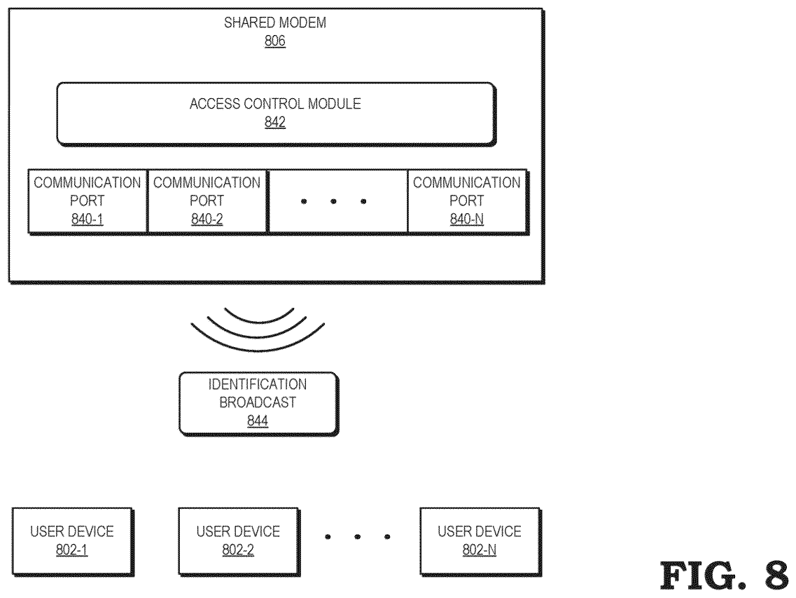

Referring now to FIG. 8, a discovery and access framework 800 for an external shared modem is presented. Discovery and access framework 800, for example, is configured to make one or more external shared modems 806, similar to or the same as shared modems 106, 206, 406, discoverable and accessible (e.g., connectable) to one or more user devices 802, similar to or the same as user devices 102, 202, 302, 402. To this end, a shared modem 806 within discover and access framework 800 includes access control module 802. Access control module 802 includes hardware-based circuitry, software-based circuitry, or both configured to transmit identification broadcast 844 using one or more communication protocols that include, for example, Universal Serial Bus (USB), Thunderbolt, Ethernet, Bluetooth (e.g., Bluetooth Low Energy), Near Field Communication (NFC), Radio Frequency ID (RFID), Wi-Fi, ultra-wideband (UWB) communications, or any combination thereof. Identification broadcast 844 includes, for example, data identifying shared modem 806, for example, a security certificate, a signature (e.g., device signature, port signature), a unique identifier, an address (e.g., uniform resource locator, port address), or any combination thereof, data indicating abilities of shared modem 806 (e.g., cellular networks supported by shared modem 806), or both.

In embodiments, one or more user devices 802 receive identification broadcast 844 using one or more communication protocols associated with the identification broadcast 844 (e.g., the communication protocols used to transmit identification broadcast 844). For example, one or more user devices 802 are configured to scan for and receive an identification broadcast 844 from one or more external shared modems 806 using one or more communication protocols (e.g., USB, Thunderbolt, Ethernet, Bluetooth (e.g., Bluetooth Low Energy), NFC, RFID, Wi-Fi, UWB). Though the example embodiment illustrated in FIG. 8 presents discovery and access framework 800 as having three user devices (802-1, 802-2, 802-N) representing an N number of user devices, in other embodiments discover and access framework 800 may have any number of user devices 802 (e.g., user devices 802 that receive identification broadcast 844). In response to receiving identification broadcast 844, a user device 802 is configured to verify the received identification broadcast 844, for example, to determine if the external shared modem 806 identified by identification broadcast 844 is a trusted device. For example, a user device 802 is configured to compare identification information (e.g., a security certificate, a signature, a unique identifier, an address) to one or more certificates, public keys, or both. In response to determining at least a portion of the identification information in identification broadcast 844 matches one or more certificates, public keys, or both, the user device 102 determines that shared modem 806 is a trusted device. Conversely, in response to determining at least a portion of the identification information in identification broadcast 844 does not match one or more certificates, public keys, or both, the user device 102 determines that shared modem 806 is not a trusted device. After verifying the shared modem 806 indicated by a received identification broadcast 844 (e.g., after determining shared modem 806 is a trusted device), a user device 802 is configured to transmit one or more connection requests to the shared modem 806 using one or more communication protocols (e.g., the communication protocol on which the identification broadcast 844 was received). Such connection requests, for example, include data requesting a connection (e.g., a secure connection, transport layer security (TLS) connection), data identifying the user device 802 (e.g., a signature, unique identifier, address), or both.

According to embodiments, shared modem 806 includes one or more communication ports 840. Each communication port 840 includes hardware-based circuitry, software-based circuitry, or both configured to transmit and receive data using one or more communication protocols (e.g., USB, Thunderbolt, Ethernet, Bluetooth (e.g., Bluetooth Low Energy), NFC, RFID, Wi-Fi, UWB). Though the example embodiment illustrated in FIG. 8 presents shared modem 806 having three communication ports (840-1, 840-2, 840-N) representing an N number of communication ports 840, in other embodiments, shared modem 806 may have any number of communication ports. In embodiments, one or more communication ports 840 are configured to receive a connection request from one or more user devices 802. For example, in some embodiments, shared modem 806 includes one or more predetermined communication ports 840 each configured to listen for one or more connections requests from the user devices 802 using one or more communication protocols. In response to receiving a connection request, access control module 842 is configured to authenticate the user device 802 identified in the connection request. For example, access control module 842 is configured to compare identification information in the connection request to one or more tables, public keys, private keys, certificates, or any combination thereof to authenticate the user device 802. In response to at least a portion of the identification information in the connection request matching one or more tables, public keys, private keys, certificates, or any combination thereof, access control module 842 authenticates the user device 802 and establishes a connection (e.g., secure connection, TLS connection) to the user 802 using one or more communication protocols.

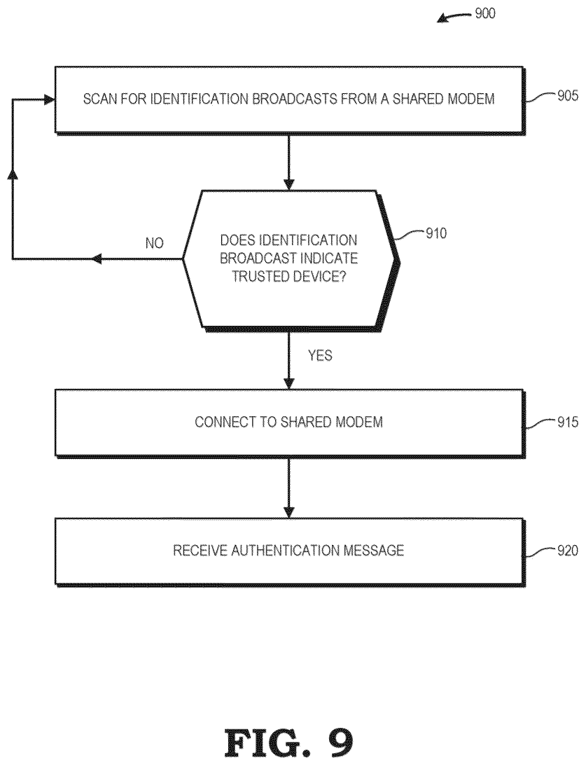

Referring now to FIG. 9, an example method 900 for discovering and accessing an external shared modem is presented. At step 905, example method 900 includes a user device, similar to or the same as user devices 102, 202, 302, 402, 802, scanning for one or more identification broadcasts (e.g., identification broadcast 844) from one or more shared modems (e.g., external shared modems), similar to or the same as shared modems 106, 206, 306, 406, 806. In embodiments, the user device scans for an identification broadcast using one or more communication protocols (e.g., USB, Thunderbolt, Ethernet, Bluetooth (e.g., Bluetooth Low Energy), NFC, RFID, Wi-Fi, UWB). At step 910, in response to discovering and receiving an identification broadcast from a shared modem, the user device is configured to determining if the shared modem identified in the identification broadcast is a trusted device. To this end, the user device compares one or more public keys, certificates, or both to identification information (e.g., a security certificate, a signature, a unique identifier, an address) indicated in the identification broadcast. In response to at least a portion of the identification information (e.g., a security certificate, a signature, a unique identifier, an address) not matching one or more public keys, certificates, or both, the system repeats 905 and the user device scans for another identification broadcast.

Referring again to step 910, in response to at least a portion of the identification information (e.g., a security certificate, a signature, a unique identifier, an address) matching one or more public keys, certificates, or both, the system moves to step 915. At step 915, the user device transmits a connection request to the shared modem identified in the identification broadcast. Such a connection request, for example, includes data requesting a connection (e.g., a secure connection, TLS connection), data identifying the user device (e.g., a signature, unique identifier, address), or both. In response to receiving the connection request, the shared modem authenticates the user device by, for example, comparing data identifying the user device (e.g., a signature, unique identifier, address) in the connection request to one or more tables, public keys, private keys, certificates, or any combination thereof. In response to at least a portion of data identifying the user device in the connection request matching one or more tables, public keys, private keys, certificates, or any combination thereof, the shared modem authenticates the user device and transmits an authentication message to the user device. Such an authentication message, for example, includes data indicating a connection (e.g., secure connection, TLC connection) has been formed between the user device and the shared modem. At step 920, the user device receives the authentication message from the shared modem.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
by a shared modem separate and distinct from a user device, communicatively coupling to the user device, wherein the user device comprises a subscriber identity module (SIM) device;
in response to receiving identification data stored in the SIM device of the user device, transmitting the identification data to a cellular network;
determining a registration parameter based on an authentication response received from the cellular network in response to transmitting the identification data; and
transmitting a network message received from the cellular network to the user device based on the determined registration parameter.

2. The method of claim 1, further comprising:
in response to communicatively coupling to the user device, transmitting a registration request associated with the user device to the cellular network.

3. The method of claim 1, further comprising:
by the shared modem, communicatively coupling to a second user device that includes a second SIM device; and
transmitting, by the shared modem, identification data stored in the second SIM device to the cellular network.

4. The method of claim 1, wherein the user device includes a telephony framework configured to output at least a portion of the network message.

5. The method of claim 1, further comprising:
receiving, from the user device, a message transmit request; and
transmitting a second network message to the cellular network based on the message transmit request and the determined registration parameter.

6. The method of claim 1, wherein the user device includes a telephony framework configured to receive an input.

7. The method of claim 6, further comprising:
determining a network message to transmit to the cellular network based on the input and the determined registration parameter.

8. The method of claim 1, wherein the transmitted network message comprises a telephone call.

9. The method of claim 1, wherein the shared modem is disposed in a second user device.

10. A method comprising:
by a shared modem, communicatively coupling to a plurality of user devices, each user device of the plurality of user devices including a respective subscriber identity module (SIM) device; and
by the shared modem, implementing at least a portion of an authentication process for a cellular network and each user device of the plurality of user devices, wherein offloading the at least a portion of the authentication process for the cellular network and each user device of the plurality of user devices comprises:
transmitting identification data stored in a respective SIM device associated with the user device to the cellular network;
determining a registration parameter for a respective user device based on a network message received from the cellular network.

11. The method of claim 10, wherein a first user device of the plurality of user devices is communicatively coupled to the shared modem using a first communication protocol and a second user device of the plurality of user devices is communicatively coupled to the shared modem using a second communication protocol different from the first communication protocol.

12. The method of claim 10, further comprising:
receiving a transmit message request from a user device of the plurality of user devices; and
determining a network message to transmit to the cellular network based on the transmit message request and a respective registration parameter.

13. The method of claim 10, wherein at least one user device of the plurality of user devices does not include an internal modem.

14. The method of claim 10, wherein offloading the at least a portion of the authentication process for the cellular network and each user device further comprises:
in response to communicatively coupling to a respective user device, generating a user device registration request; and
transmitting the user device registration request to the cellular network.

15. The method of claim 10, wherein at least one user device of the plurality of user devices includes a telephony frame configured to output a telephone call received from the cellular network.

16. The method of claim 10, wherein at least one user device of the plurality of user devices includes an internal modem in a low-power state.

17. The method of claim 10, wherein the shared modem is disposed in at least one user device of the plurality of user devices.

18. The method of claim 1, wherein the shared modem is configured to communicatively couple to at least one user device using a communication protocol of a plurality of communication protocols.

19. The method of claim 1, wherein the shared modem is connected to an alternating current (A/C) power source.

20. The method of claim 1, wherein the identification data includes an authentication key.

21. (canceled)

22. An apparatus for offloading one or more network messages between a user device and a cellular network, the apparatus comprising:
a shared modem communicatively coupleable to one or more user devices and a cellular network;
one or more processors; and
a memory coupled to the one or more processors and storing executable instructions configured to manipulate one or both of the one or more processors or the shared modem to:
communicatively couple the shared modem to the user device, wherein the user device comprises a subscriber identity module (SIM) device;
in response to receiving identification data stored in the SIM device of the user device, transmit the identification data to the cellular network;
determine a registration parameter based on an authentication response received from the cellular network in response to transmitting the identification data; and
provide a network message received from the cellular network for transmission to the user device based on the determined registration parameter.

23. The apparatus of claim 22, wherein the executable instructions further are configured to manipulate one or both of the one or more processors or the shared modem to:
in response to communicatively coupling to the user device, provide a registration request associated with the user device for transmission to the cellular network.

24. The apparatus of claim 22, wherein the executable instructions further are configured to manipulate one or both of the one or more processors or the shared modem to:
communicatively couple the shared modem to a second user device that includes a second SIM device; and
provide identification data stored in the second SIM device for transmission by the shared modem to the cellular network.

25. The apparatus of claim 22, wherein the shared modem is disposed in a second user device.
